(19) United States
(12) Patent Application Publication
(10) Pub. No.: US 2026/0201942 A1
(43) Pub. Date: Jul. 16, 2026

(54) VARIABLE OFFSET CRANKSHAFT

(71) Applicant: Snap-on Incorporated, Kenosha, WI (US)

(72) Inventors: Bryan J. Kordus, Kenosha, WI (US); Jack H. Stickney, Kenosha, WI (US)

(73) Assignee: Snap-on Incorporated, Kenosha, WI (US)

(21) Appl. No.: 19/017,094

(22) Filed: Jan. 10, 2025

(51) Int. Cl. F16H 21/52; B25B 21/00

(52) U.S. Cl. CPC F16H 21/52; B25B 21/004

(57) ABSTRACT

A crankshaft having a crank pin with a continually variable offset that is based on a rotational operating speed of a tool in order to provide high torque during high loading situations and higher speed as loading decreases. The crankshaft includes a crankshaft base that interfaces with a drive mechanism of the tool, a crank pin slider with a crank pin that interfaces with an output of the tool, and a bias member that biases the crank pin slider with respect to the crankshaft base. As a rotational speed of the crankshaft increases, inertial effects on the crank pin slider cause the crank pin slider to move against the bias of the bias member to a larger offset position to allow the output speed of the tool to increase. This allows a power ratchet type tool to operate at a variable torque and speed based on torque load.

### FIELD OF INVENTION

The present invention relates generally to power tools, and more particularly to crankshafts for power ratchet type tools.

### BACKGROUND OF THE INVENTION

Power tools, such as power ratchets, and other types of tools, are commonly used in automotive, industrial, and household applications to install and remove threaded fasteners and apply a torque and/or angular displacement to a work piece, such as, for example, a threaded fastener. Many power tools are portable and electrically powered, such as with a rechargeable battery, allowing a user to apply torque or force to a workpiece without exerting a substantial amount of energy. Power ratchet type tools generally include a crankshaft with a crank pin that drives oscillating motion of a yoke, which selectively rotates a drive lug in one of either first and second rotational directions. However, the crank pin design is typically offset from a rotational axis of the crankshaft by a fixed distance, which limits the ability of current power ratchet type tools to operate at varying rotational speeds while also being able to provide varying amounts of torque application.

### SUMMARY OF THE INVENTION

The present invention relates broadly to a crankshaft for a power tool, such as a power ratchet type tool. The crankshaft has a crank pin with a continually variable offset that is based on an operating speed of the tool in order to provide high torque during high loading situations and increased speed as loading decreases. In an embodiment, the crankshaft includes a crankshaft base that interfaces with a drive mechanism of the tool, a crank pin slider with a crank pin that interfaces with an output of the tool (such as a yoke of a ratchet mechanism), and a bias member (such as a spring) that biases the crank pin slider to a first offset position (i.e., a minimum offset position or low offset position) of the crankshaft base when the tool is not being used or the crankshaft is operating at a low rotational speed. As the rotational speed of the crankshaft increases, inertial effects on the crank pin slider cause the crank pin slider to move in a first direction against the bias of the bias member (e.g., compressing the spring) to a larger offset position to allow the output speed of the tool to increase. On the other hand, when the rotational speed of the crankshaft decreases, the bias member will overcome the inertial effects and cause the crank pin slider to move in a second direction to return the crank pin slider to the first offset position. This allows, among other things, a power ratchet type tool to operate at a torque and speed that varies based on torque load of a torquing operation being performed.

In an embodiment, the present invention relates broadly to a crankshaft for a tool with a drive mechanism and an output mechanism. The crankshaft includes a crankshaft base having opposing first and second end portions, wherein the first end portion is adapted to operably couple to the drive mechanism, and a crank pin slider with a crank pin that is adapted to be operably coupled to the output mechanism, wherein the crank pin slider is slidably coupled to the second end portion of the crankshaft base.

In another embodiment, the present invention relates broadly to a tool with a motor, a drive mechanism operably coupled to the motor, a crankshaft, and an output mechanism. The crankshaft includes a crankshaft base having opposing first and second end portions, wherein the first end portion is operably coupled to the drive mechanism, and a crank pin slider with a crank pin is operably coupled to the output mechanism, wherein the crank pin slider is slidably coupled to the second end portion of the crankshaft base.

### BRIEF DESCRIPTION OF DRAWINGS

For the purpose of facilitating an understanding of the subject matter sought to be protected, there is illustrated in the accompanying drawing embodiments thereof, from an inspection of which, when considered in connection with the following description, the subject matter sought to be protected, its construction and operation, and many of its advantages, should be readily understood and appreciated.

FIG. 1 is a side view of an exemplar crankshaft disposed in a first offset position, according to an embodiment of the present invention.

FIG. 2 is a cross-sectional view of the exemplar crankshaft of FIG. 1, taken along line A-A.

FIG. 3 is a side view of the exemplar crankshaft disposed in a second offset position, according to an embodiment of the present invention.

FIG. 4 is a cross-sectional view of the exemplar crankshaft of FIG. 3, taken along line B-B.

FIGS. 5 and 6 are exploded, perspective views of an exemplar crankshaft, according to an embodiment of the present invention.

FIG. 7 is a partial perspective view of a crankshaft base of an exemplar crankshaft, according to an embodiment of the present invention.

FIGS. 8A and 8B are perspective bottom views of a crank pin slider of an exemplar crankshaft, according to an embodiment of the present invention.

FIG. 9 is a first side view of an exemplar tool incorporating a crankshaft, according to an embodiment of the present invention.

FIG. 10 is a partial exploded side view of the exemplar tool of FIG. 9, with a portion of a housing removed showing exemplar internal components, according to an embodiment of the present invention.

FIG. 11 is a second side view of the exemplar tool of FIG. 9 incorporating a crankshaft, according to an embodiment of the present invention.

FIG. 12 is a first cross-sectional view of a head portion of the exemplar tool of FIG. 9 taken along line C-C in FIG. 11, with the exemplar crankshaft disposed in a first offset position, according to an embodiment of the present invention.

FIG. 13 is a second cross-sectional view of a head portion of the exemplar tool of FIG. 9 taken along line C-C in FIG. 11 with the exemplar crankshaft disposed in a second offset position, according to an embodiment of the present invention.

### DETAILED DESCRIPTION OF THE INVENTION

While the present invention is susceptible of embodiments in many different forms, there is shown in the drawings, and will herein be described in detail, a preferred embodiment of the invention with the understanding that the present disclosure is to be considered as an exemplification of the principles of the invention and is not intended to limit the broad aspect of the invention to embodiments illustrated. As used herein, the term “present invention” is not intended to limit the scope of the claimed invention and is instead a term used to discuss exemplary embodiments of the invention for explanatory purposes only.

The present invention relates broadly to a crankshaft for a power tool, such as a power ratchet type tool. The crankshaft has a crank pin with a continually variable offset that is based on an operating rotational speed of the tool in order to provide high torque during high loading situations and increased speed as loading decreases. In an embodiment, the crankshaft includes a crankshaft base that interfaces with a drive mechanism of the tool, a crank pin slider with a crank pin that interfaces with an output of the tool (such as a yoke of a ratchet mechanism), and a bias member (such as a spring) that biases the crank pin slider to a first offset position (e.g., a minimum offset position or low offset position) of the crankshaft base when the tool is not being used or the crankshaft is operating at a low rotational speed. As the rotational speed of the crankshaft increases, inertial forces on the crank pin slider cause the crank pin slider to move in a first direction against the bias of the bias member (e.g., compressing the spring) to a larger offset position to allow the output speed of the tool to increase. On the other hand, when the rotational speed of the crankshaft decreases, the bias member will overcome the inertial forces and cause the crank pin slider to move in a second direction to return the crank pin slider to the first offset position. This allows, among other things, a power ratchet type tool to operate at a torque and speed that varies based on torque load of a torquing operation being performed.

For example, with the crank pin slider being biased to the first offset position, the crankshaft allows the tool to have the most amount of torque when needed to, for example, initially break a fastener loose, such as with a fastener that is “frozen” due to corrosion. Once the fastener is broken loose, the amount of torque that is required to continually drive the fastener drops, which allows the tool to increase the rotational speed of the crankshaft. As the rotational speed increases, the inertial effects cause the crank pin slider to move to a larger offset position to allow the output speed of the tool to increase and remove the fastener more quickly. The opposite is true when tightening a fastener.

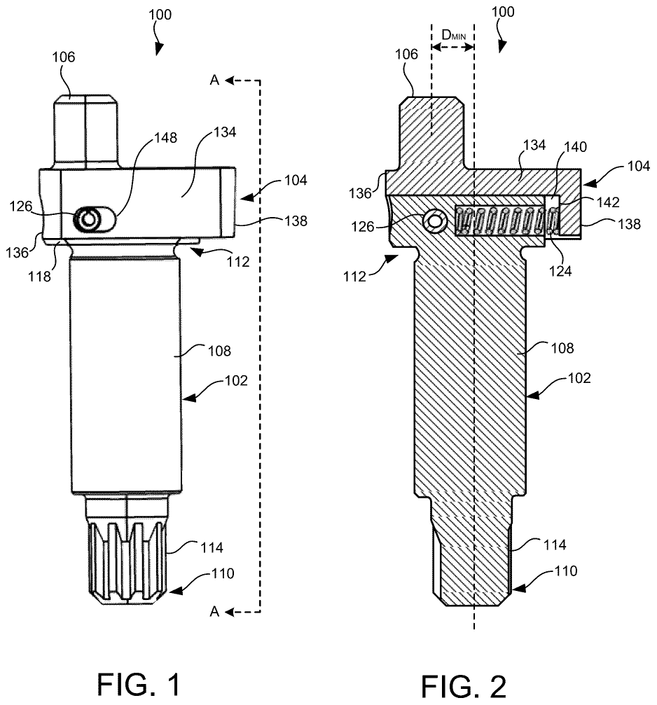

Referring to FIGS. 1-6, an exemplar crankshaft 100 for a power tool (such as a powered ratchet type tool) includes a crankshaft base 102 that is adapted to operably interface with a drive mechanism of the tool (such as a gear mechanism and/or a motor output shaft, as described in further detail below), a crank pin slider 104 with a crank pin 106 that is adapted to operably interface with an output assembly/mechanism of the tool (such as a yoke of a ratchet type mechanism), and a bias member (such as a spring, for example) that biases the crank pin slider 104 with respect to a longitudinal axis of the crankshaft base 102. The crankshaft base 102 includes a shaft portion 108 having opposing first and second end portions 110, 112. The first end portion 110 is adapted to operably interface with a drive mechanism of the tool (such as a gear mechanism and/or motor output shaft, as described in further detail below).

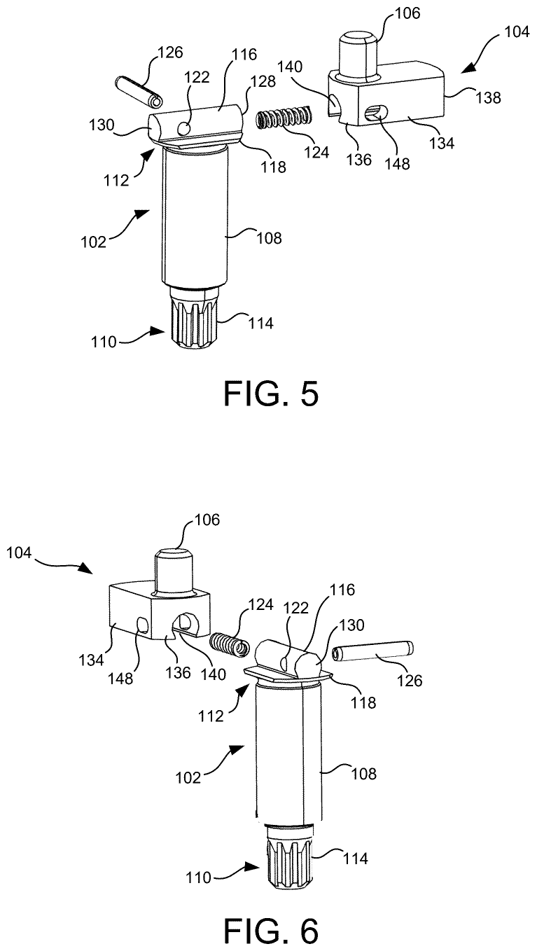

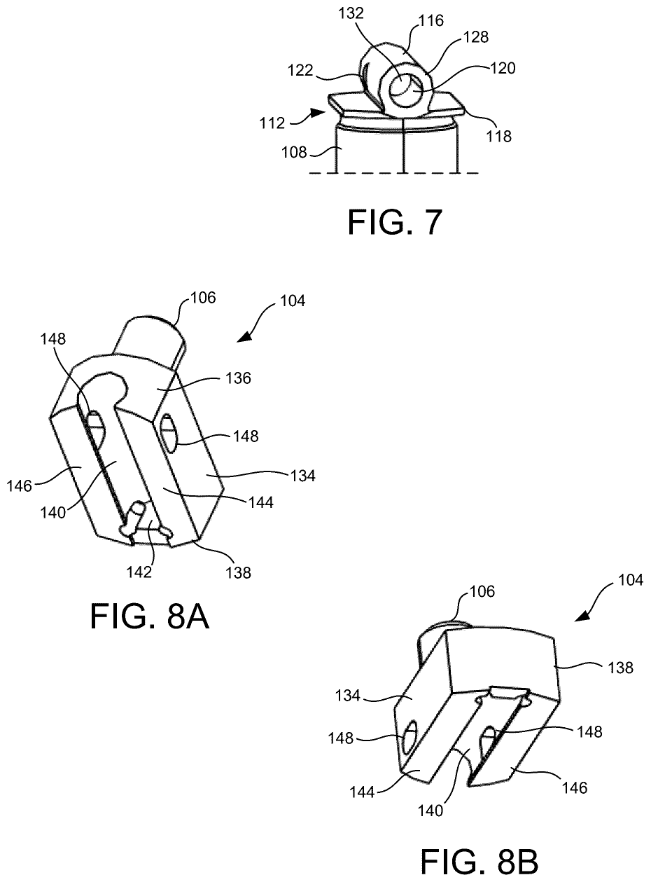

For example, the first end portion 110 may include a gear portion 114 with gear teeth. The second end portion 112 is adapted to slidably couple to the crank pin slider 104 via a slide type joint. In an embodiment, as shown in FIGS. 5-7, the second end portion 112 includes an elongated projection 116 that extends substantially perpendicular to a longitudinal or rotational axis of the shaft portion 108, and flange type ledges 118 on opposing sides of the elongated projection 116. However, the elongated projection 116 can extend at angles other than substantially perpendicular to the longitudinal or rotational axis of the shaft portion 108. For example, the elongated projection 116 can extend at a non-zero angle relative to a plane extending perpendicular to the longitudinal or rotational axis of the shaft portion 108. The elongated projection 116 is also adapted to be disposed in a corresponding channel of the crank pin slider 104, and the ledges 118 are adapted to cooperatively form a guiding/sliding surface for the crank pin slider 104.

As illustrated in FIGS. 5 and 6, the elongated projection 116 of the crankshaft base 102 and the corresponding channel of the crank pin slider 104 have substantially partial arcuate cross-sectional shapes. However, other shapes can be used that provide a sliding connection or joint between the crankshaft base 102 and the crank pin slider 104. For example, a T-shaped or dove-tail type sliding joint, or other type of sliding type joint connection could be used.

The crankshaft base 102 also includes a blind-hole 120 and a through-hole 122, in which the blind-hole 120 is adapted to receive a bias member 124 (such as a spring, for example), and the through-hole 122 is adapted to receive a fastening member 126 to couple the crankshaft base 102 and crank pin slider 104 together. Referring to FIGS. 5-7, the elongated projection 116 incudes opposing first and second ends 128, 130. The blind-hole 120 is formed in and extends into the first end 128 and terminates at an end surface 132 within the elongated projection 116, and the through-hole 122 extends transversely (i.e., in a direction perpendicular to the blind-hole 120) through the elongated projection 116 between the end surface and the second end of the elongated projection 116.

The crank pin slider 104 includes a slider base 134 having opposing first and second base ends 136, 138, and a crank pin 106 extending from a top surface of the slider base 134. A channel 140 is formed in the slider base 134 and extends from the first end 136 in a direction towards the second end 138. The channel 140 may also terminate at an interior end wall 142 proximal to the second end 138. The channel 140 may be open at a bottom end, and have a cross-sectional shape that substantially mates with the cross-sectional shape of the elongated projection 116 of the crankshaft base 102. The cross-sectional shapes of the elongated projection 116 and the channel 140 may also be shaped such that the crank pin slider 104 is slidable onto the elongated projection 116 in a lateral direction and restricted from being removed from the elongated projection 116 in a direction perpendicular to the lateral direction.

The channel 140 of the crank pin slider 104 may form first and second sidewall portions 144, 146, each of which includes an elongated or oblong through-hole 148. The through-holes 148 are located proximal to the first end 136 generally below a location of the crank pin 106, and the through-holes 148 are adapted to substantially align with the through-hole 122 of the crankshaft base 102.

The bias member 124 is disposed in the blind-hole 120 of the crankshaft base 102. The first end 136 and channel 140 of the crank pin slider 104 are substantially aligned with the elongated projection 116 of the crankshaft base 102, with the first end 136 facing the blind-hole 120, and the crank pin slider 104 is slid onto the elongated projection 116. The crank pin slider 104 is slidably received onto the elongated projection 116 until the through-holes 148 of the crank pin slider 104 substantially align with the through-hole 122 of the crankshaft base 102, and the fastening member 126 is disposed in or otherwise inserted into the through-holes 148 and through-hole 122.

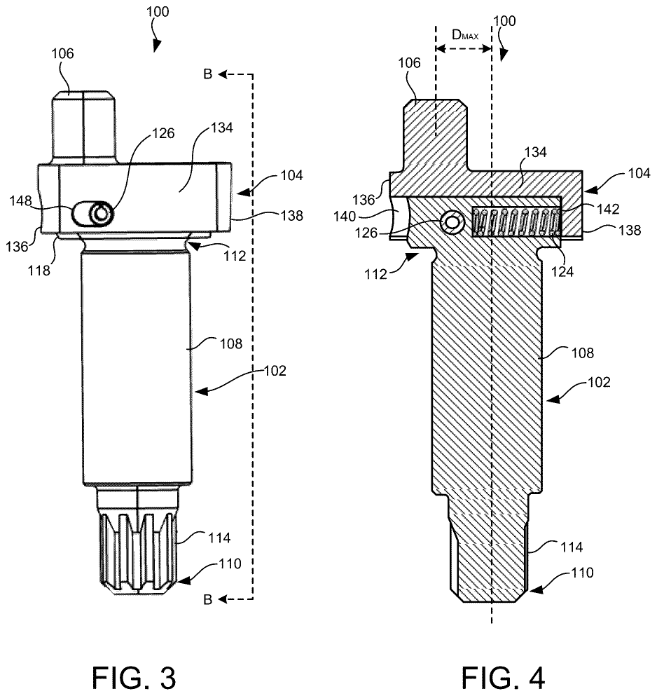

The bias member 124 is seated between the end surface 132 within the elongated projection 116 (i.e., end of the blind-bore 120) and the interior end wall 142 of the crank pin slider 104. Accordingly, as shown in FIGS. 1 and 2, the bias member 124 biases the crank pin slider 104 to a first offset position D_{MIN} (i.e., a minimum offset position or low offset position) with respect to a rotational axis of the crankshaft base 102. When in the first offset position D_{MIN}, the ends of the through-holes 148 proximal to the first end 136 of the crank pin slider 104 abut or otherwise contact the fastening member 126. The oblong or elongated shape of the through-holes 148 allow the crank pin slider 104 to slide with respect to the crankshaft base 102 and fastening member 126. Accordingly, as shown in FIGS. 3 and 4, when the crank pin slider 104 is moved against the bias of the bias member 124 (e.g., compressing the bias member) to a second offset position D_{MAX} (i.e., a maximum offset position or high offset position) with respect to the rotational axis of the crankshaft base 102, the ends of the through-holes 148 distal to the first end 136 of the crank pin slider 104 abut or otherwise contact the fastening member 126.

When installed in a tool, the crank pin slider 104 is biased to the first offset position D_{MIN} (i.e., a minimum offset position or low offset position) with respect to the crankshaft base 102 when the tool is not being used or when the crankshaft 100 is otherwise rotating at a low rotational speed that is not enough to overcome the bias. As the rotational speed of the crankshaft 100 increases, inertial forces on the crank pin slider 104 cause the crank pin slider 104 to move with respect to the crankshaft base 102 against the bias of the bias member 124 to a larger offset position to allow the output speed of the tool to increase, until the crank pin slider 104 is moved to the largest offset position (i.e., the second offset position D_{MAX} described above). On the other hand, when the rotational speed of the crankshaft 100 decreases, the bias member 124 overcomes the inertial forces and causes the crank pin slider 104 to move in an opposite direction until the crank pin slider 104 is returned to the first offset position D_{MIN}. The size and spring constant or spring rate of the bias member 124 can be varied or selected based on the desired operation of the tool. In other words, desired operation of the tool can be modified or customized during manufacturing based on the selection of the size and/or spring constant or spring rate of the bias member 124.

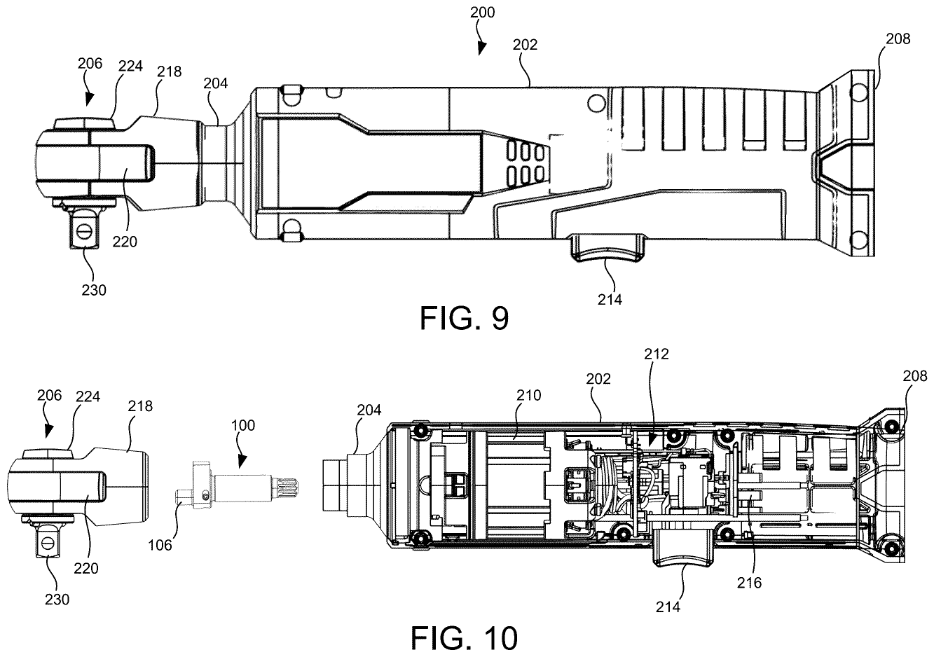

Referring to FIGS. 9-13, an exemplar tool 200 incorporating the crankshaft 100 is illustrated. The exemplar tool 200 includes a motor housing portion 202 (also referred to as a handle housing portion), a neck housing portion 204 that houses the crankshaft 100 and is operably coupled to the motor housing portion 202, and an output assembly 206 that is operably coupled to the neck housing portion 204. The motor housing portion 202 may function as a handle of the tool 200 and includes a grip for a user to hold and manipulate the tool 200 during use.

The motor housing portion 202 may include first and second housing portions (respectively forming first and second sides of the motor housing portion 202). In an embodiment, the motor housing portion 202 is a clamshell-type housing, where the first and second housing portions are coupled together via fasteners to cooperatively form the motor housing portion 202. In another embodiment, the motor housing portion 202 (including the first and second housing portions) may be a single integrated or monolithic piece.

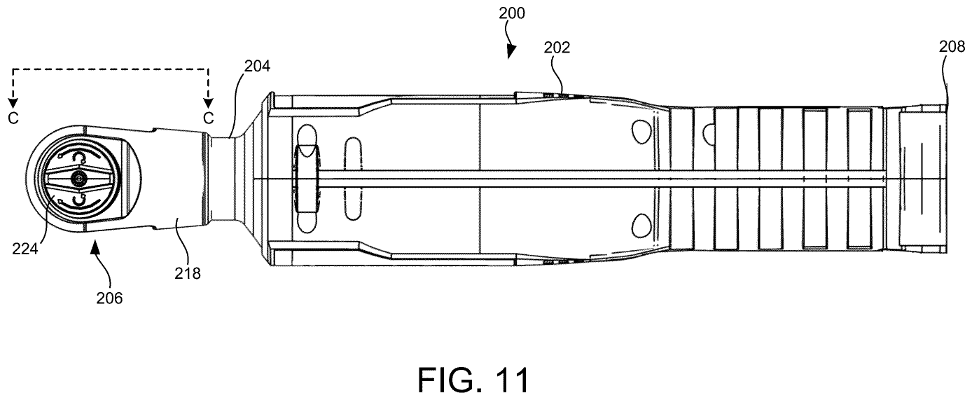

The motor housing portion 202 may extend from the neck housing portion 204 to a power source receiving end 208 that is adapted to receive and couple to a power source, such as, for example, a removable battery pack, for providing power to the tool 200. As shown in FIG. 10, the motor housing portion 202 may house a motor 210, control electronics 212, and an actuatable trigger 214 that is adapted to operate the motor 210 and thereby the output assembly 206. The motor 210 is disposed in and supported in the motor housing portion 202 and operably coupled to the trigger 214 via the control electronics 212. The motor 210 may be a brushless DC (BLDC) or a brushed-type motor, or any other suitable motor (e.g., pneumatically or hydraulically operated or AC operated motor). The motor 210 may include a motor shaft that is operably coupled to the output assembly 206. Thus, actuation of the trigger 214 by a user (such as depression of the trigger 214) causes the motor 210 to operate, thereby causing the output assembly 206 to rotate.

The control electronics 212 may include, for example, motor control electronics operably coupled to and adapted to control the motor 210. For example, the motor control electronics may include a motor printed circuit board (PCB) that is operably coupled to the trigger 214 and motor 210. The motor PCB may include one or more switching elements disposed thereon. The switching elements may be field effect transistors (FETs), such as, for example, metal-oxide semiconductor field-effect transistors (MOSFETs). In an embodiment, the switching elements may include three high-side switching elements, H1, H2, and H3, and three low-side switching elements, L1, L2, and L3, each of which being operable in either one of a first or conducting state and a second or non-conducting state. The switching elements are controlled to selectively apply power from a power source (e.g., a battery pack) to the motor 210 to achieve desired commutation. By selectively activating particular high-side and low-side switching elements, the motor 210 is operated by having the motor PCB send a current signal through coils located on a stationary part of the motor 210, typically called a stator. The coils cause a magnetic force to be applied to a rotating part of the motor 210, typically called a rotor, when current runs through the coils. The rotor includes permanent magnets that interact with magnetic forces created by the windings of the stator. By selectively activating successive combinations of high and low-side switching elements in a particular order, thereby sending a particular order of current signals through the windings of the stator, the stator creates a rotating magnetic field which interacts with the magnets on the rotor to cause the rotor to rotate, which causes rotation of the motor shaft, in a well-known manner.

The control electronics 212 may also include, for example, a power printed circuit board (PCB) that is operably coupled to the motor control electronics, power receiving terminals 216, and the trigger 214. The power receiving terminals 216 are adapted to be operably coupled to a power source, such as a removable battery pack, to provide power to the tool 200. In an embodiment, the trigger 214 is operably coupled to the power PCB and motor control electronics. Actuation of the trigger 214 (such as depression of the trigger 214) causes power to be supplied to the motor 210 and the motor 210 to operate and rotate the motor shaft in either one of first and second (e.g., forward and reverse or clockwise and counter-clockwise) rotational directions, in a well-known manner.

In an embodiment, the trigger 214 is a linearly depressible trigger that is depressible inwardly, relative to the tool 200, to cause the tool 200 to operate, and release of the trigger 214 causes the trigger 214 to bias outwardly, relative to the tool 200, to cease operation of the tool 200. The trigger 214 and control electronics 212 may also operate via a variable speed type mechanism. In this regard, actuation or depression of the trigger 214 can cause the motor 210 to rotate the motor shaft at a faster speed the further the trigger 214 is depressed. In another embodiment, the trigger 214 may be a rocker type of trigger switch, where depression of a top portion (portion proximal to the output assembly 206) of the trigger 214 causes the tool 200 to operate in a first rotational direction (such as a clockwise rotational direction), and depression of a bottom portion (portion distal to the output assembly 206) of the trigger 214 causes the tool 200 to operate in a second rotational direction (such as a counter-clockwise rotational direction).

The neck housing portion 204 is hollow and houses the crankshaft 100 that is operably coupled to the motor 210. In an embodiment, the crankshaft 100 may be operably coupled to the motor 210 via a gear mechanism. The gear mechanism may include a ring gear with internal gear teeth that meshingly engage gear teeth of one or more pinion gears that are operably coupled to a carrier. In this embodiment, a motor gear on the motor shaft of the motor 210 meshingly engages the gear teeth of the pinion gears, and the gear portion 114 at the first end portion 110 of the crankshaft 100 meshingly engage with gear teeth of the carrier. Thus, rotation of the motor shaft of the motor 210 causes rotation of the crankshaft 100. The crankshaft 100 may also be rotationally supported in the neck housing 204 via one or more bearings, such as bearings disposed around an external surface of the crankshaft 100.

The output assembly 206 includes a head housing portion 218, a yoke 220 disposed in the head housing portion 218, and an output mechanism 222 disposed in the yoke 220 and head housing portion 218. The output mechanism 222 may include a selector switch 224, a pawl carrier 226, one or more pawls 228, and an output drive lug 230. The drive lug 230 is adapted to apply torque to a work piece, such as a fastener, via an adapter, bit, or socket coupled to the drive lug 230, such as a bi-directional ratcheting square or hexagonal drive. As illustrated, the drive lug 230 is a “male” connector adapted to fit into or matingly engage a female counterpart. However, the drive lug 230 may alternately include a “female” connector designed to matingly engage a male counterpart. The drive lug 230 may also be structured to directly engage a work piece without requiring coupling to an adapter, bit, or socket. The rotational direction of the drive lug 230 can also be selected by rotation of the selector switch 224 to be either a first or second rotational direction (such as, clockwise or counterclockwise).

The crank pin 106 of the crankshaft 100 is disposed in a recess 232 of the yoke 220, and a bushing 234 may also be disposed on the crank pin 106 and interface with the surfaces forming the recess 232. Thus, when the trigger 214 is actuated (such as via depression of the trigger 214) power is supplied to the motor 210 and causes the motor 210 to operate and rotate the motor shaft, which causes rotation of the crankshaft 100, via the gear mechanism. Rotation of the crankshaft 100 causes oscillating motion of the yoke 220, via the crank pin 106, which causes rotation of the output mechanism 222 and drive lug 230 in one of the selected first and second rotational directions (based on a position of the selector switch 224).

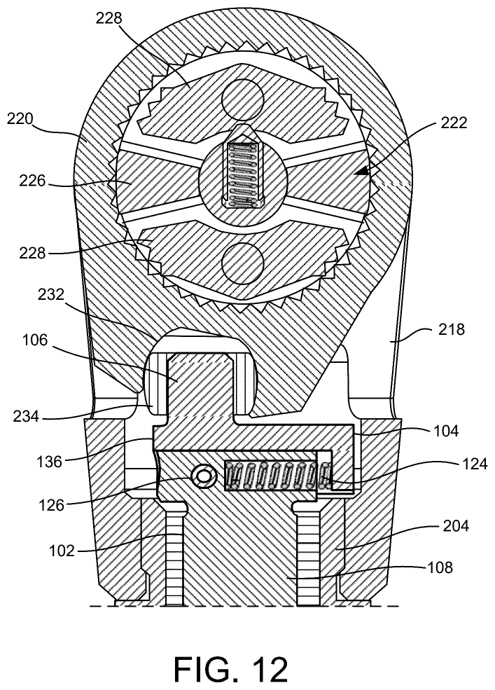

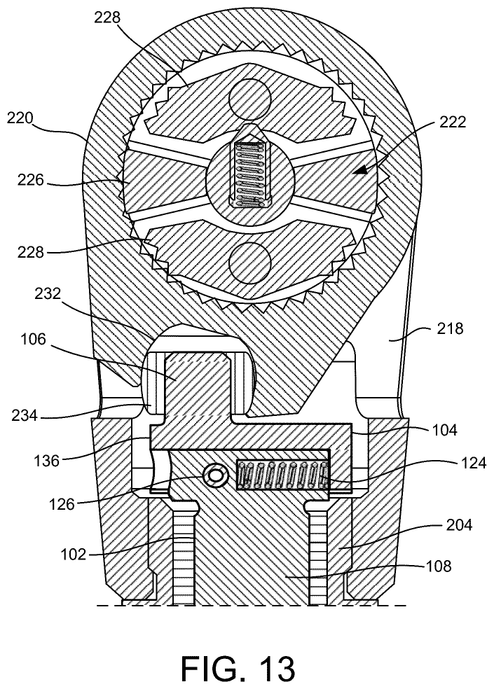

Referring to FIGS. 12 and 13, the crank pin slider 104 of the crankshaft 100 is biased to the first offset position D_{MIN} (i.e., a minimum offset position or low offset position) with respect to the crankshaft base 102 when the tool 200 is not being operated (i.e., power is not being supplied to the motor 210) or the crankshaft 100 is rotating at a low rotational speed that is not enough to overcome the bias of the bias member. When the tool is operated (i.e., the trigger 214 is actuated and causes power to be supplied to the motor 210) to cause rotation of the crankshaft 100 and as the rotational speed of the crankshaft 100 increases, inertial forces on the crank pin slider 104 cause the crank pin slider 104 to move with respect to the crankshaft base 102 against the bias of the bias member 124 to a larger offset position to allow the output speed of the tool to increase, until the crank pin slider 104 is moved to the largest offset position (i.e., the second offset position D_{MAX} described above). On the other hand, when the rotational speed of the crankshaft 100 decreases, the bias member 124 overcomes the inertial forces and causes the crank pin slider 104 to move in an opposite direction until the crank pin slider 104 is returned to the first offset position D_{MIN}. This allows a power ratchet type tool, such as tool 200, to operate at a torque and speed that varies based on torque load of a torquing operation being performed.

For example, with the crank pin slider 104 biased to the first offset position, the crankshaft 100 allows the tool 200 to have the most amount of torque application when needed to break a fastener loose. Once the fastener breaks loose, the amount of torque required to continually rotate the fastener drops, which allows the tool 200 to increase the rotational speed of the crankshaft 100. As the rotational speed increases, the inertial forces cause the crank pin slider 104 to move to a larger offset position to allow the output speed of the tool 200 to increase to rotate the fastener more quickly. The opposite is true when installing a fastener.

As discussed herein, the tool is a powered ratchet type tool. However, the tool can be any electrically powered or hand-held tool, including, without limitation, a powered torque wrench type tool, drill, or other powered rotary type tool that is capable of being operated via an offset crank pin, that is powered by electricity via a power source (such as a wall outlet and/or generator outlet) or a battery. While the tool is described as powered by a battery, the tool may be power by other electrical power sources, such as an external wall outlet, etc.

As used herein, the term “coupled” and its functional equivalents are not intended to necessarily be limited to direct, mechanical coupling of two or more components. Instead, the term “coupled” and its functional equivalents are intended to mean any direct or indirect mechanical, electrical, or chemical connection between two or more objects, features, work pieces, and/or environmental matter. “Coupled” is also intended to mean, in some examples, one object being integral with another object. As used herein, the term “a” or “one” may include one or more items unless specifically stated otherwise.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. A crankshaft for a tool with a drive mechanism and an output mechanism, the crankshaft comprising:
a crankshaft base having opposing first and second end portions, wherein the first end portion is adapted to operably couple to the drive mechanism; and
a crank pin slider having a crank pin that is adapted to operably couple to the output mechanism, wherein the crank pin slider is slidably coupled to the second end portion of the crankshaft base.

2. The crankshaft of claim 1, further comprising a bias member disposed in the crankshaft base and adapted to bias the crank pin slider to a first offset position.

3. The crankshaft of claim 1, wherein the second end portion of the crankshaft base includes a projection, and the crank pin slider includes a channel that is adapted to slidably receive the projection.

4. The crankshaft of claim 3, wherein the projection and the channel have a partial arcuate cross-sectional shape.

5. The crankshaft of claim 3, wherein the projection includes a blind-hole and a bias member is disposed in the blind-hole.

6. The crankshaft of claim 5, further comprising a first through-hole disposed in the projection, and a fastening member disposed in the first through-hole.

7. The crankshaft of claim 6, further comprising a second through-hole disposed in the crank pin slider, wherein the fastening member is disposed in the first and second through-holes.

8. The crankshaft of claim 7, wherein the second through-hole has an elongated shape that is adapted to allow the crank pin slider to move relative to the crankshaft base and the fastening member.

9. The crankshaft of claim 1, wherein the crankshaft base is adapted to be rotated by the drive mechanism, and as a rotational speed of the crankshaft base increases, inertial forces on the crank pin slider cause the crank pin slider to move relative to the crankshaft base.

10. The crankshaft of claim 1, wherein the first end portion of the crankshaft base includes gear teeth.

11. A tool having a motor and a drive mechanism, the tool comprising:
a crankshaft including:
a crankshaft base having opposing first and second end portions, wherein the first end portion is operably coupled to the drive mechanism; and
a crank pin slider with a crank pin, wherein the crank pin slider is slidably coupled to the second end portion of the crankshaft base; and
an output mechanism operably coupled to the crank pin.

12. The tool of claim 11, wherein the crankshaft further includes a bias member disposed in the crankshaft base and adapted to bias the crank pin slider to a first offset position.

13. The tool of claim 11, wherein the second end portion of the crankshaft base includes a projection, and the crank pin slider includes a channel adapted to slidably receive the projection.

14. The tool of claim 13, wherein the projection and the channel have a partial arcuate cross-sectional shape.

15. The tool of claim 13, wherein the projection includes a blind-hole and a bias member is disposed in the blind-hole.

16. The tool of claim 15, wherein the crankshaft further includes a first through-hole disposed in the projection, and a fastening member disposed in the first through-hole.

17. The tool of claim 16, wherein the crankshaft further includes a second through-hole disposed in the crank pin slider, wherein the fastening member is disposed in the first and second through-holes.

18. The tool of claim 17, wherein the second through-hole has an elongated shape adapted to allow the crank pin slider to move relative to the crankshaft base and the fastening member.

19. The tool of claim 11, wherein the crankshaft base is adapted to be rotated by the drive mechanism, and as a rotational speed of the crankshaft base increases inertial effects on the crank pin slider cause the crank pin slider to move relative to the crankshaft base.

20. A crankshaft for a tool with a drive mechanism and an output mechanism, the crankshaft comprising:
a crankshaft base having opposing first and second end portions, wherein the first end portion includes gear teeth adapted to operably couple to the drive mechanism, and the second end portion includes a projection with a blind-hole and a first through-hole;
a crank pin slider having a channel that slidably receives the projection, a crank pin that is adapted to operably couple to the output mechanism, and a second through-hole;
a fastening member disposed in the first and second through-holes, wherein the second through-hole has an elongated shape that is adapted to allow the crank pin slider to move relative to the crankshaft base and the fastening member; and
a bias member disposed in the blind-hole and adapted to apply a bias force to the crank pin slider and bias the crank pin slider to a first offset position, wherein inertial forces on the crank pin slider overcome the bias force as a rotational speed of the crankshaft base increases and cause the crank pin slider to move relative to the crankshaft base towards a second offset position.
